(19) United States
(12) Patent Application Publication
(10) Pub. No.: US 2007/0157274 A1
(43) Pub. Date: Jul. 5, 2007

(54) SYSTEM AND METHOD FOR TESTING MULTIMEDIA DEVICE

(75) Inventor: WEN-TING CHIU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,762

(22) Filed: Sep. 22, 2006

(30) Foreign Application Priority Data
Dec. 23, 2005 (TW) 094146337

(51) Int. Cl. H04N 7/173; H04N 7/18; H04N 9/47

(52) U.S. Cl. 725/107; 348/92

(57) ABSTRACT

A system for testing a plurality of multimedia devices is provided, the system comprising a first multi-input device, a second multi-input device, a video-capturing device, and a console. The first multi-input device is connected to one end of each of the plurality of multimedia devices, for transmitting original video data to the plurality of multimedia devices. The second multi-input device is connected to the other end of each of the plurality of multimedia devices. The video capturing device is connected to the second multi-input device. The second multi-input device is used for switching connections between the plurality of multimedia devices and the video capturing device. The console is connected to the first multi-input device for controlling the first multi-input device, and connected to the video capturing device for controlling the video capturing device to capture a static image from each of the plurality of multimedia devices, and for comparing the static image with the original video data to determine whether one or more of the plurality of multimedia devices passes a test.

### 1. FIELD OF THE INVENTION

The invention relates to a system and a method, and particularly to a system and a method for testing a multimedia device.

### 2. DESCRIPTION OF RELATED ART

Image quality is a key criterion of assessing multimedia devices such as a set top box. Due to noise and resetting of a digital signal processor (DSP), a user is likely to detect defects in a display image, particularly when using a freeze frame function. Therefore, it is very important to test a display effect of the multimedia device during production thereof. A traditional method employs a manual test method, which tests the display effect of the multimedia device by monitoring a screen manually. This method is time-consuming and inefficient.

### SUMMARY OF THE INVENTION

A system for testing a plurality of multimedia devices comprises a first multi-input device, a second multi-input device, a video-capturing device, and a console. The first multi-input device is connected to one end of each of the plurality of multimedia devices, for transmitting original video data to the plurality of multimedia devices. The second multi-input device is connected to the other end of each of the plurality of multimedia devices. The video capturing device is connected to the second multi-input device. The second multi-input device is used for switching connections between the plurality of multimedia devices and the video capturing device. The console is connected to the first multi-input device for controlling the first multi-input device, and connected to the video capturing device for controlling the video capturing device to capture the static image from each of the plurality of multimedia devices, and for comparing a static image with the original video data, in order to determine whether one or more of the plurality of multimedia devices passes a test.

A method for testing a plurality of multimedia devices is also provided, the method including setting test parameters; controlling a second multi-input device to switch connections between a plurality of multimedia devices and a video capturing device according to the test parameters; capturing a static image from test video data generated by the plurality of multimedia devices after a predetermined time interval; transferring the static image to the console; and comparing the static image with original video data.

Other advantages and novel features will become more apparent from the following detailed description when taken in conjunction with the accompanying drawings, in which:

### BRIEF DESCRIPTION OF THE DRAWINGS

FIG. 1 is an overall architecture diagram of a system of an exemplary embodiment of the invention;

FIG. 2 is a schematic diagram of a second multi-input device of the exemplary embodiment of the invention;

FIG. 3 is a block diagram of a console of the exemplary embodiment of the invention; and

FIG. 4 is a flowchart of a method of another embodiment of the invention.

### DETAILED DESCRIPTION OF THE INVENTION

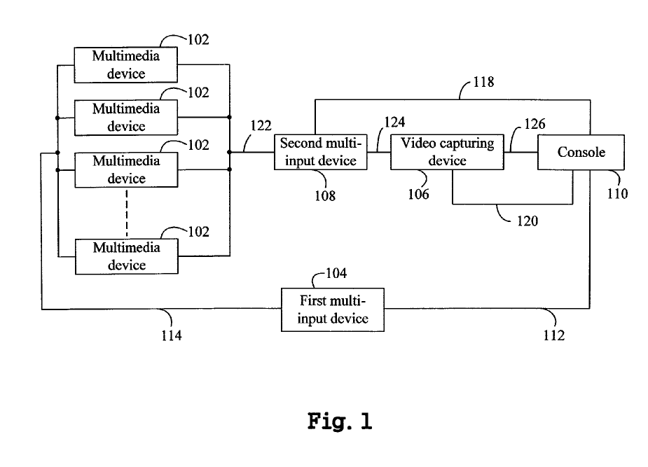

FIG. 1 is an overall architecture diagram of a system of an exemplary embodiment of the invention.

In this embodiment, the system for testing a plurality of multimedia devices 102 includes a first multi-input device 104, a video capturing device 106, a second multi-input device 108, and a console 110.

The first multi-input device 104 allocates an identification code to each of the plurality of multimedia devices 102, and transmits original video data to the plurality of devices 102 for playing. In this embodiment, the first multi-input device 104 is connected to the console 110 via a first communication line 112, and to the plurality of multimedia devices 102 via a second communication line 114. The identification code may be an Internet protocol (IP) address. Using the identification code, the console 110 is able to transfer original video data to the multimedia devices 102 and record the multimedia devices 102 failing a test. Video data after playing are referred to as test video data.

The video capturing device 106 is used for capturing a static image from the test video data after a predetermined time interval, and for transferring a captured static image to the console 110. In this embodiment, the video capturing device 106 is connected to the console 110 via a fifth communication line 126 and a second parallel line 120, and to the second multi-input device 108 via a fourth communication line 124.

The second multi-input device 108 is used for switching connections between the multimedia devices 102 and the video capturing device 106. In this embodiment, the second multi-input device 108 is connected to the multimedia devices 102 via a third communication line 122.

The console 110 is used for controlling the first multi-input device 104, the video capturing device 106 and the second multi-input device 108, and for comparing the captured static image with original video data. In this embodiment, the console 110 is connected to the second multi-input device 108 via a first parallel line 118.

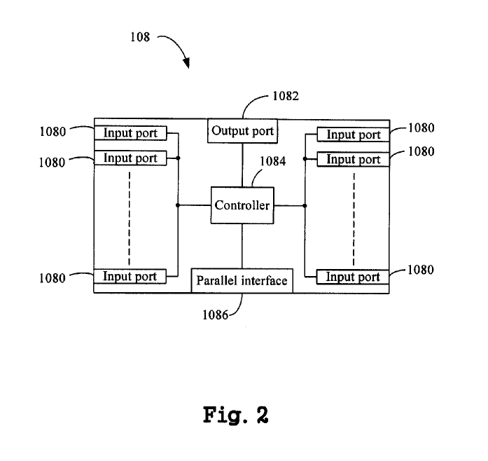

FIG. 2 is a schematic diagram of the second multi-input device 108 of the embodiment of the invention.

The second multi-input device 108 includes a plurality of input ports 1080, an output port 1082, a controller 1084, and a parallel interface 1086. The input ports 1080 are connected to the multimedia devices 102 of FIG. 1 for receiving test video data therefrom. The output port 1082 is connected to the video capturing device 106 of FIG. 1 for transferring the test video data thereto. The controller 1084 is connected to the plurality of multi-input ports 1080, the output port 1082, and the parallel interface 1086, for receiving a command from the console 110 of FIG. 1 via the parallel interface 1086, and to control a connection between the plurality of input ports 1080 and the output port 1082 based on the command. The parallel interface 1086 is connected to the console 110.

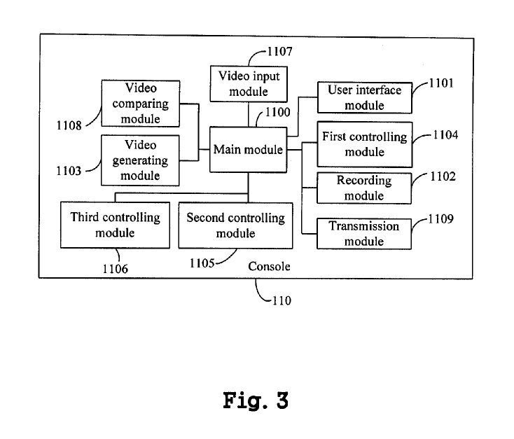

FIG. 3 is a block diagram of the console 110 of the embodiment of the invention.

In this embodiment, the console 110 includes a main module 1100, a user interface module 1101, a recording module 1102, a video generating module 1103, a first controlling module 1104, a second controlling module 1105, a third controlling module 1106, a video input module 1107, a video comparing module 1108, and a transmission module 1109.

The main module 1100 is used for controlling the user interface module 1101, the recording module 1102, the video generating module 1103, the first controlling module 1104, the second controlling module 1105, the third controlling module 1106, the video input module 1107, the video comparing module 1108, and the transmission module 1109. The main module 1100 determines whether test files and test parameters have been correctly set. In this embodiment, the main module 1100 can be a computer operating system.

The user interface module 1101 acts as a test interface. A user may input various test parameters, such as the number of the multimedia devices 102 to be tested, an identification code of each of the multimedia devices 102, and a test sequence of each of the multimedia devices 102 via the user interface module 1101.

The recording module 1102 is used for recording test results, including an identification code of each of the plurality of multimedia devices that fail the test, and a static image of each of the plurality of multimedia devices that fail the test.

The video generating module 1103 is used for generating original video data and transferring the original video data to the multimedia devices 102 for playing.

The first controlling module 1104 is used for controlling the first multi-input device 104 to allocate the identification code to the multimedia devices 102, in order to transfer the original video data to the multimedia devices 102.

The second controlling module 1105 is used for controlling the second multi-input device 108 to switch to a next multimedia device 102 according to the test sequence.

The third controlling module 1106 is used for controlling the video capturing device 106 to capture the static image from the test video data.

The video input module 1107 is used for receiving the static image from the video capturing device 106, and for transferring the static image to the video comparing module 1108.

The video comparing module 1108 is used for comparing the original video data with the static image, to examine whether the test video data from one or more of the multimedia devices 102 are correct, thereby determining whether one or more of the multimedia devices 102 passes the test.

The transmission module 1109 is used for transferring the original video data and the static image to one of the multimedia devices 102 and the video input module 1107, respectively.

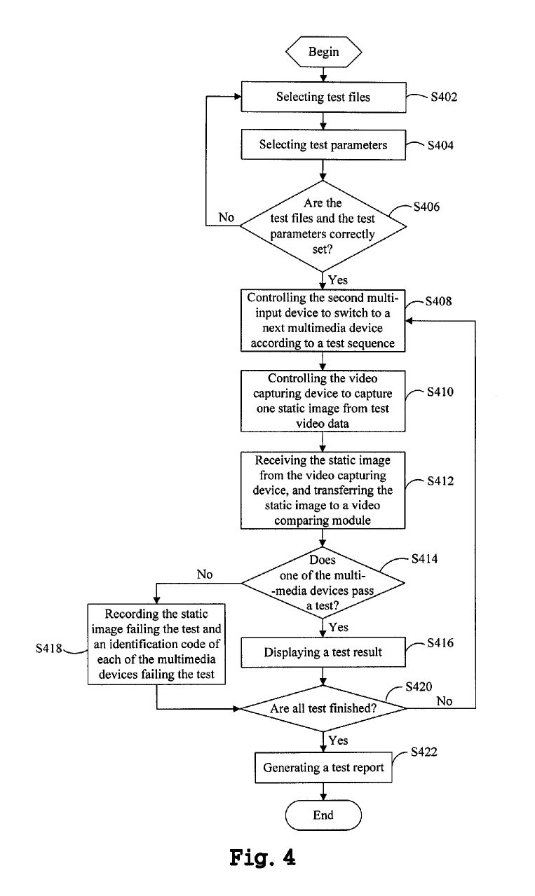

FIG. 4 is a flowchart of a method of another embodiment of the invention. In this embodiment, only one of the multimedia devices 102 is tested each time.

In step S402, the user selects test files via the user interface module 1101. In this embodiment, the test files can be in a format of Moving Picture Expert Group (MPEG)-2. It should be understood that the test files are not limited to this format, and other formats, such as Advanced System Format (ASF), can be used.

In step S404, the user sets test parameters via the user interface module 1101. In this embodiment, the test parameters include the process controlling value, the identification codes of the multimedia devices 102, the capturing frequency of the test video data, the test sequence of the multimedia devices 102, and so on. The process controlling value represents the total number of the multimedia devices 102 to be tested. When one of the multimedia devices 102 is tested, the process controlling value is automatically decremented by 1.

In step S406, the main module 1100 determines whether the test files and the test parameters are correctly set. If the test files and the test parameters are not correctly set, the process returns to step S402. If the test files and the test parameters are correctly set, the process proceeds to step S408.

In step S408, the second controlling module 1105 controls the second multi-input device 108 to switch to a next multimedia device 102 according to the test sequence, in order to transfer the test video data of the next multimedia device 102 to the video capturing device 106 via the second multi-input device 108.

In step S410, the third controlling module 1106 controls the video capturing device 106 to capture one static image from the test video data after a predetermined time interval.

In step S412, the video input module 1107 receives the static image from the video capturing device 106, and transfers the static image to the video comparing module 1108.

In step S414, the video comparing module 1108 compares original video data with the static image and determines whether one of the multimedia device 102 passes the test.

In this embodiment, the static image comprises multiple pixels. When comparing the static image with the original video data, the video comparing module 1108 calculates mean absolute error (MAE) of the static image and the original video data, which are respectively represented as MAE1 and MAE2, then calculate an absolute value of a difference between MAE1 and MAE2. MAE1 is derived from the following equation:

MAE1=[MAE1(R)+MAE1(G)+MAE1(B)]/3,

where MAE1(R), MAE1(G), and MAE1(B) represent MAE of Red, Green, and Blue color of all pixels in the static image, respectively. MAE2 is derived from the following equation:

MAE2=[MAE2(R)+MAE2(G)+MAE2(B)]/3,

where MAE2(R), MAE2(G), and MAE2(B) represent MAE of Red, Green, and Blue color of all pixels in the original video data, respectively. It should be understood that the invention is not limited to the above-mentioned method, and the comparison can also be implemented by comparing mean square error (MSE) of the static image with that of the original video data.

If the absolute value of the MAE difference between the static image and the original video data is less than or equal to a preset value, which is 1 in this embodiment, that indicates one of the multimedia device 102 passes the test. The process proceeds to step S416, where a test result is displayed. In this embodiment, the test result is displayed as “PASS” or “OK” on the console.

If the absolute value of the difference between the static image and the original video data is larger than a preset value, that indicates one of the multimedia device 102 fails the test. The process proceeds to step S418, where the recording module 1102 records the static image failing the test, and the identification code each of the multimedia devices 102 failing the test.

In step S420, the main module 1100 checks the test parameters to determine whether all tests are finished. In this embodiment, the main module 1100 checks whether the process controlling value is equal to 0. If the process controlling value is equal to 0, that indicates all the tests are finished, and the process proceeds to step S422, where the main module 1100 generates a test report, and displays the test report on the console 110. If the process controlling value is not equal to 0, that indicates not all the tests are finished, and the process returns to step S410.

In this embodiment, the test report includes the identification code of each of the multimedia devices 102 failing the test, the static image failing the test, and the identification code of each of the multimedia devices 102 passing the test.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A system for testing a plurality of multimedia devices, comprising:
a first multi-input device connected to one end of each of the plurality of multimedia devices, for transmitting original video data to the plurality of multimedia devices;
a second multi-input device connected to the other end of each of the plurality of multimedia devices;
a video capturing device connected to the second multi-input device, the second multi-input device being used for switching connections between the plurality of multimedia devices and the video capturing device; and
a console connected to the first multi-input device for controlling the first multi-input device, and connected to the video capturing device for controlling the video capturing device to capture a static image from each of the plurality of multimedia devices, and for comparing the static images with the original video data to determine whether one or more of the plurality of multimedia devices passes a test.

2. The system of claim 1, wherein the console is further connected to the second multi-input device for controlling the second multi-input device.

3. The system of claim 1, wherein the second multi-input device further comprises:
a plurality of input ports connected to the plurality of multimedia devices for receiving test video data therefrom;
an output port connected to the video capturing device for transferring the test video data thereto;
a parallel interface connected to the console; and
a controller connected to the plurality of input ports, the output port and the parallel interface, for receiving a command from the console via the parallel interface, and controlling the connection between the plurality of input ports and the output port based on the command.

4. The system of claim 1, wherein the first multi-input device is further for allocating an identification code for each of the plurality of multimedia devices.

5. The system of claim 4, wherein the console further comprises:
a video generating module for generating the original video data;
a first controlling module for controlling the first multi-input device to allocate the identification code to the plurality of multimedia devices and transfer the original video data to the multimedia devices for playing;
a second controlling module for controlling the second multi-input device to switch to a next multimedia device;
a third controlling module for controlling the video capturing device to capture the static image from the test video data; and
a video comparing module for comparing the original video data with the static image.

6. The system of claim 5, wherein the video data after playing is referred to as the test video data.

7. The system of claim 1, wherein the console further comprises:
a video input module for receiving the static image from the video capturing device, and for transferring the static image to the video comparing module;
a transmission module for transferring the original video data and the static image to one of the plurality of multimedia devices and the video input module, respectively;
a user interface module acting as a test interface; and
a recording module for recording test results.

8. The system of claim 7, wherein the test results comprises an identification code of each of the plurality of multimedia devices that fail the test, a static image of each of the plurality of multimedia devices that fails the test, and an identification code of each of the plurality of multimedia devices that pass the test.

9. A method for testing a plurality of multimedia devices, comprising:
setting test parameters;
controlling a multi-input device to switch connections between a plurality of multimedia devices and a video capturing device according to the test parameters;
capturing a static image from test video data generated by the plurality of multimedia devices after a predetermined time interval;
transferring the static image to the console; and
comparing the static image with original video data to determine whether one or more of the multimedia device passes the test.

10. The method of claim 9, further comprising:
displaying the test results if one or more of the plurality of multimedia devices passes the test; and
recording the static image failing the test and the identification code of the plurality of multimedia devices failing the test if one or more of the plurality of multimedia devices fails the test.

11. The method of claim 10, further comprising selecting test files.

12. The method of claim 11, further comprising determining whether the test files and the test parameters are correctly set.

13. The method of claim 12, wherein the test parameters comprise the number of the multimedia devices to be tested, an identification code of each of the multimedia devices, and a sequence of testing the multimedia devices.

14. The method of claim 13, further comprising:
checking the test parameters to determine whether all tests are finished; and
generating a test report if all the tests are finished.

15. The method of claim 14, wherein the test report comprises an identification code of each of the plurality of multimedia devices failing the test, a static image failing the test, and an identification code of each of the plurality of multimedia devices passing the test.

16. The method of claim 9, wherein the step of comparing the static image with the original video data comprises comparing an average of a mean absolute error of red, green, and blue color of each pixel of the test video data with that of the original video data.

17. A method for testing a plurality of multimedia devices, comprising:
signally communicating a console for test operation with a plurality of multimedia devices respectively via a common multi-input device;
controlling said multi-input device by said console to switch signal communication between said console and each of said plurality of multimedia devices according to a test sequence;
capturing an image for testing out of test video data generated by said each of said plurality of multimedia devices after a predetermined time interval when original video data is transmitted from said console to said each of said plurality of multimedia devices; and
verifying whether said each of said plurality of multimedia devices passes based on a comparative result of said captured image and said transmitted original video data.
